(19) United States
(12) Patent Application Publication
(10) Pub. No.: US 2015/0085610 A1
(43) Pub. Date: Mar. 26, 2015

(54) FIBER OPTIC DISTRIBUTED ACOUSTIC MEASUREMENTS VIA FMCW INTERROGATION

(71) Applicants: Matthew Thomas Raum, Blacksburg, VA (US); Roger Glen Duncan, Christiansburg, VA (US); Brooks A. Childers, Christiansburg, VA (US)

(72) Inventors: Matthew Thomas Raum, Blacksburg, VA (US); Roger Glen Duncan, Christiansburg, VA (US); Brooks A. Childers, Christiansburg, VA (US)

(73) Assignee: BAKER HUGHES INCORPORATED, Houston, TX (US)

(21) Appl. No.: 14/462,804

(22) Filed: Aug. 19, 2014

Related U.S. Application Data
(60) Provisional application No. 61/882,287, filed on Sep. 25, 2013.

(51) Int. Cl. G01V 1/48; G01V 1/28; G01V 1/22

(52) U.S. Cl. CPC G01V 1/48; G01V 1/226; G01V 1/288; G01V 2210/1234
USPC 367/25

(57) ABSTRACT

A system and method to obtain acoustic information from a borehole penetrating the earth are described. The system includes a light source to provide a continuous output beam and a modulator to modulate the continuous output beam with a modulation signal to provide a frequency modulated continuous wave (FMCW) to be sent out on an optical fiber disposed along the borehole, the optical fiber including a plurality of reflectors at known locations along the optical fiber. The system also includes a processor to process a light reflection signal from the optical fiber to determine the acoustic information.

### CROSS-REFERENCE TO RELATED APPLICATION

This application is a non-provisional of U.S. Provisional Application Ser. No. 61/882,287 filed Sep. 25, 2013, the disclosure of which is incorporated by reference herein in its entirety.

### BACKGROUND

In downhole exploration and production, sensors and monitoring systems provide information about the downhole environment and the formation. One of the parameters of interest is acoustic signals, which may indicate the status of and changes in drilling and formation conditions, for example.

### SUMMARY

According to an aspect of the invention, a system to obtain acoustic information from a borehole penetrating the earth includes a light source configured to provide a continuous output beam; a modulator configured to modulate the continuous output beam with a modulation signal to provide a frequency modulated continuous wave (FMCW) to be sent out on an optical fiber disposed along the borehole, the optical fiber including a plurality of reflectors at known locations along the optical fiber; and a processor configured to process a light reflection signal from the optical fiber to determine the acoustic information.

According to another aspect of the invention, a method of obtaining acoustic information from a borehole penetrating the earth includes disposing an optical fiber along the borehole, the optical fiber including a plurality of reflectors at known locations along the optical fiber; modulating a continuous output beam with a modulation signal to provide a frequency modulated continuous wave (FMCW) to be sent out on the optical fiber; and processing a light reflection signal from the optical fiber to determine the acoustic information.

### BRIEF DESCRIPTION OF THE DRAWINGS

Referring now to the drawings wherein like elements are numbered alike in the several Figures:

FIG. 1 is a cross-sectional illustration of a borehole and an acoustic sensory system according to an embodiment of the invention;

FIG. 2 is a block diagram of components of the acoustic sensor system according to an embodiment of the invention;

FIG. 3 depicts an exemplary modulation signal in the time domain;

FIG. 4 illustrates an exemplary electronic signal resulting from three reflections;

FIG. 5 illustrates an exemplary output signal and corresponding detected signal;

FIG. 6 illustrates a detected signal that includes an acoustic component; and

FIG. 7 is a process flow of a method of obtaining acoustic measurements along a fiber according to an embodiment of the invention.

### DETAILED DESCRIPTION

As noted above, downhole acoustic signals are among the parameters that are used to characterize the downhole environment. Embodiments of the system and method described herein relate to determining the movement of reflections from an optical fiber and correlating that movement to an acoustic event.

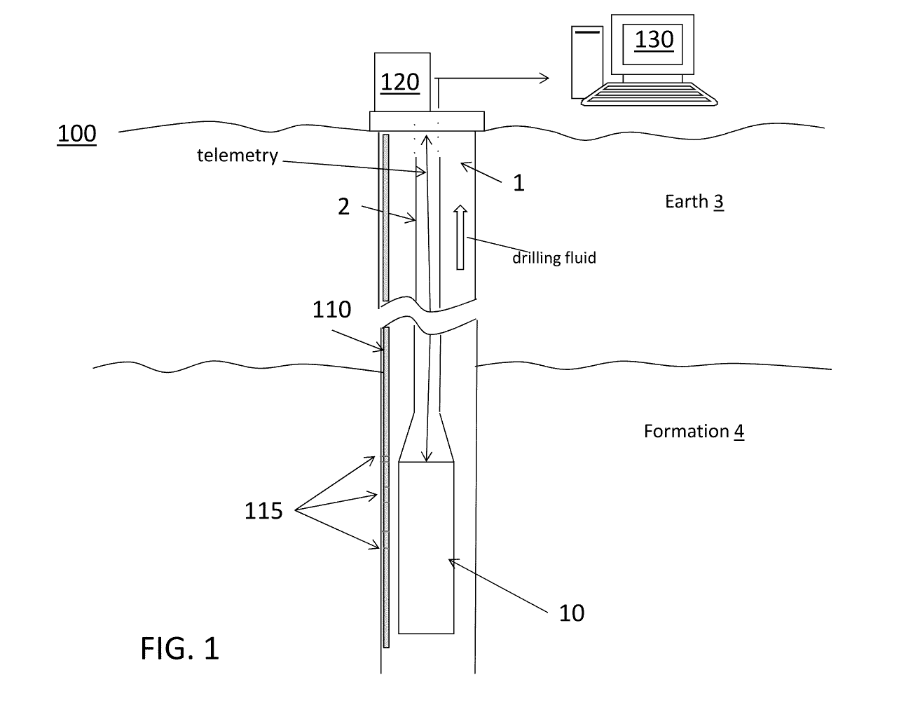

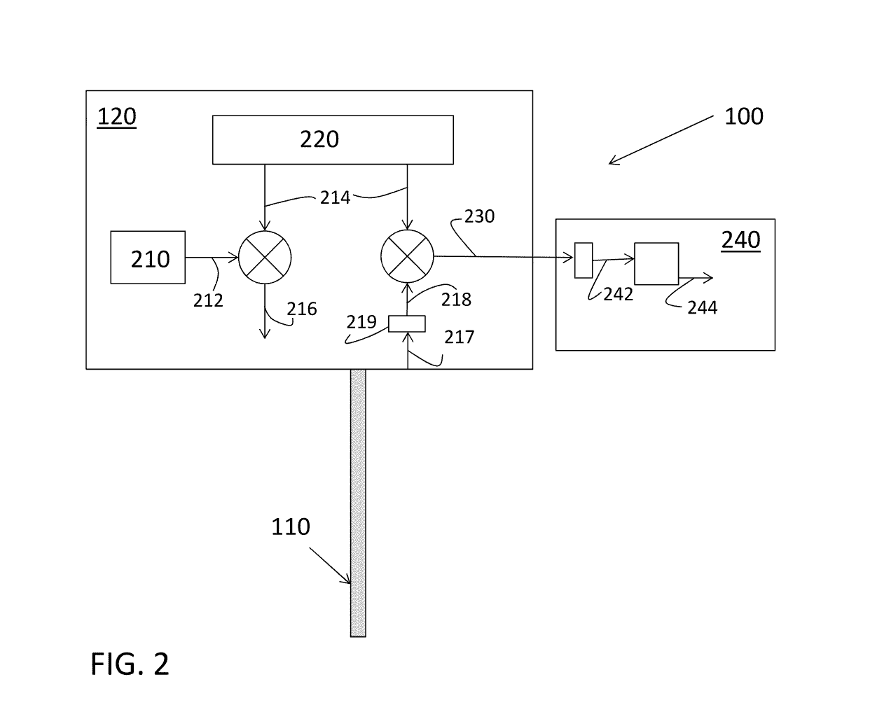

FIG. 1 is a cross-sectional illustration of a borehole 1 and an acoustic sensory system 100 according to an embodiment of the invention. The borehole 1 penetrates the earth 3 including a formation 4. A set of tools 10 may be lowered into the borehole 1 by a string 2. In embodiment of the invention, the string 2 may be a casing string, production string, an armored wireline, a slickline, coiled tubing, or a work string. In measure-while drilling (MWD) embodiments, the string 2 may be a drill string, and a drill would be included below the tools 10. Information from the sensors and measurement devices included in the set of tools 10 may be sent to the surface for processing by the surface processing system 130 via a fiber link or telemetry. The surface processing system 130 (e.g., computing device) includes one or more processors and one or more memory devices in addition to an input interface and an output interface. The acoustic sensor system 100 includes an optical fiber 110 with two or more reflectors 115 (e.g., fiber Bragg gratings (FBGs)). The reflectors 115 may be positioned at known distances apart from each other. The acoustic sensor system 100 also includes components 120 shown at the surface of the earth 3 in FIG. 1 and further detailed below with reference to FIG. 2.

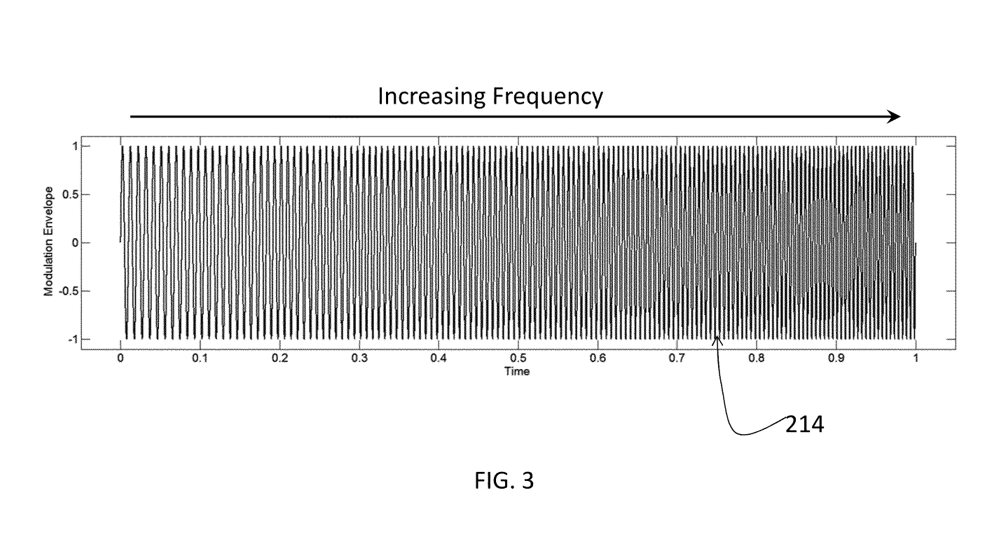

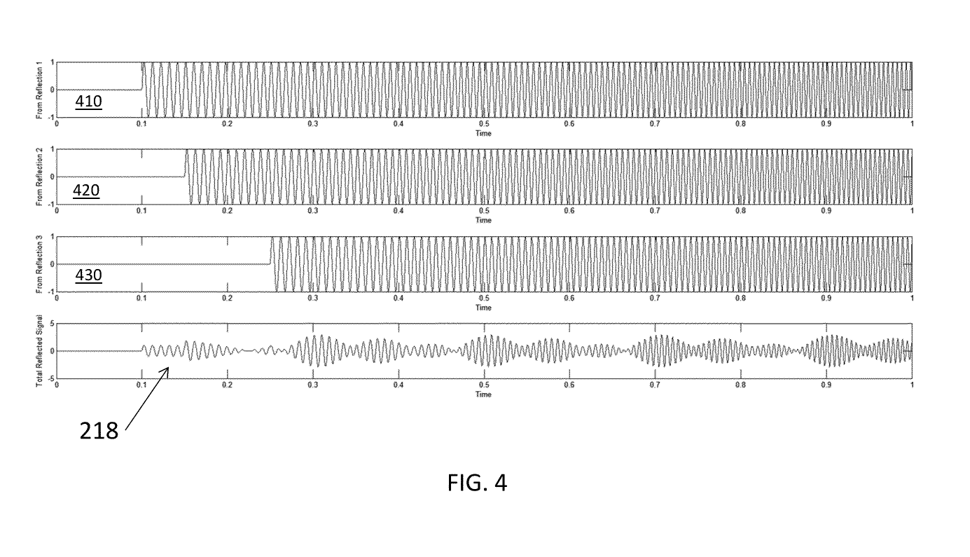

FIG. 2 is a block diagram of components 120 of the acoustic sensor system 100 according to an embodiment of the invention. A laser source 210 produces a continuous output beam 212 that is modulated by a modulation signal 214 output by a signal generator 220. FIG. 3 depicts an exemplary modulation signal 214 in the time domain (time on the x-axis). The exemplary modulation signal 214 has a sinusoidal envelope whose frequency is swept linearly in time over a given range. The modulated signal 216 resulting from modulating the continuous output beam 212 with the modulation signal 214 is a frequency modulated continuous wave (FMCW) and is sent out on the fiber 110. The reflected light 217 (resulting from the FMCW interrogation of the fiber 110) is composed of a superposition of copies of the original signal (216) with varying delays corresponding with each area of reflection (reflectors 115) on the fiber 110. The reflected light 217 is converted to an electronic signal 218 by a photodetector 219, for example. FIG. 4 illustrates an exemplary electronic signal 218 resulting from three reflections 410, 420, 430. The exemplary signals shown in FIG. 4 do not include an acoustic event. As such, the reflections 410, 420, 430 are not modulated by any acoustic noise. The electronic signal 218 representing the reflected signal is mixed with the modulation signal 214 (the reference signal) to produce an output signal 230 for further processing. The output signal 230 is a superposition of interference signals at fixed frequencies. The frequencies of the interference signals making up the output signal 230 match the frequency difference between the reflected signal (electronic signal 218) and the reference signal (modulation signal 214) and are proportional to time delays associated with the reflections that originated the reflected light 217 returned by the fiber 110.

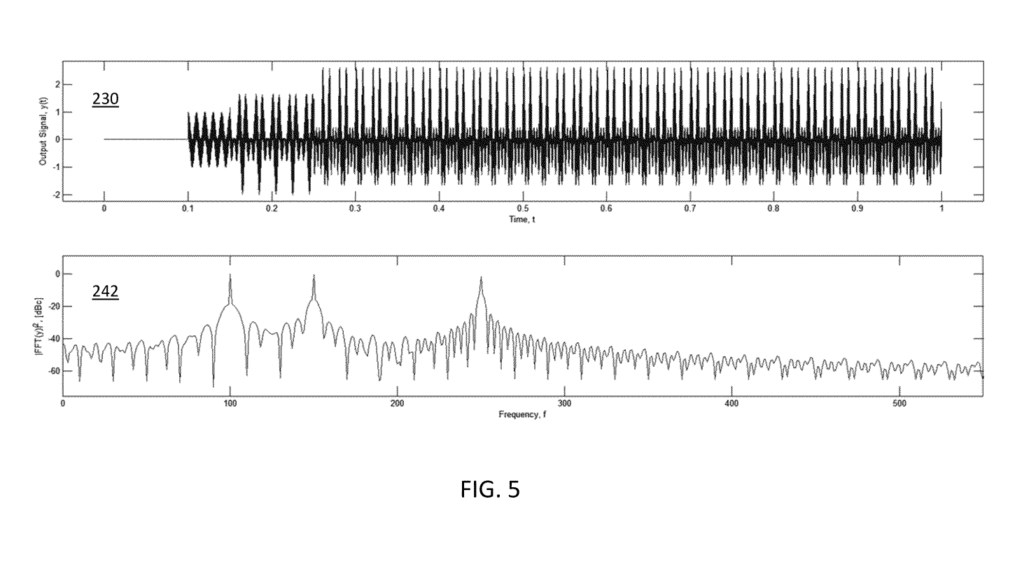

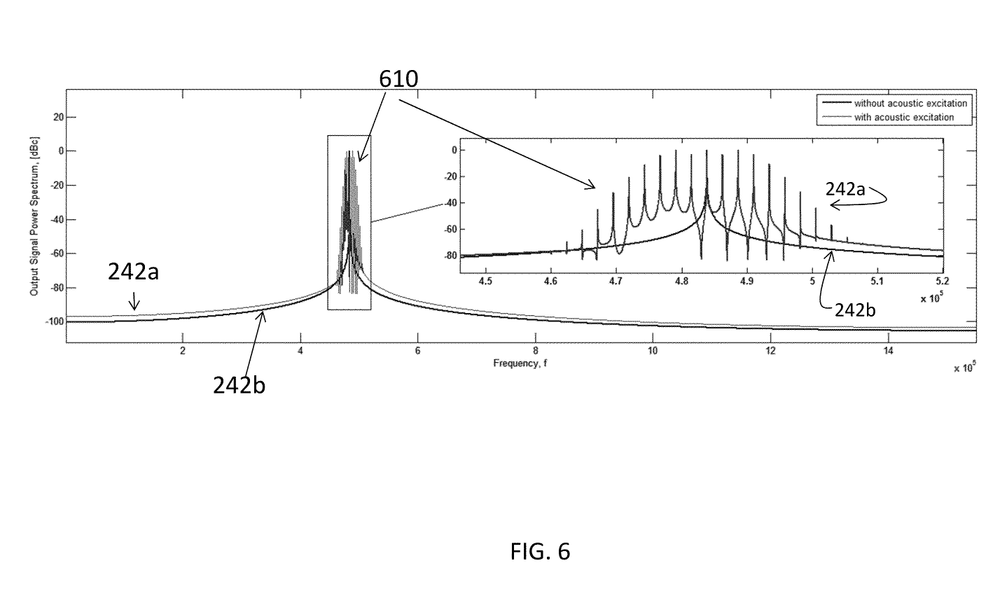

The output signal 230 may be further processed by a processor 240 (e.g., the surface processing system 130). The processor 240 may be part of the components 120, for example. During the processing, when a Fourier transform is taken of the output signal 230, the resulting detected signal 242 in the frequency domain includes peaks corresponding to reflectors 115 in the fiber 110. That is, just as the different time delays in the reflected electronic signal 218 correspond to the different reflectors 115, the different frequencies in the detected signal 242 correspond with the different reflectors 115. FIG. 5 illustrates an exemplary output signal 230 and corresponding detected signal 242. The exemplary signals in FIG. 5 do not include acoustic noise. FIG. 6 illustrates a detected signal 242 that includes an acoustic component. The detected signal 242 with (242a) and without (242b) the acoustic component are shown in FIG. 6. When acoustic excitation causes motion of a reflection event, the movement of a reflector 115 will show up in the detected signal 242 in the form of sidelobes (see e.g., 610 in FIG. 6) at the frequency corresponding with the effected reflector 115. The detected signal 242 is input to a bandpass filter and demodulator to obtain the displacement signal 244 that indicates the displacement of reflectors 115 with respect to the start of the fiber 110. By computing the difference between the obtained displacements associated with each of the reflectors 115, local measurements of the acoustic excitation between two reflection events on the fiber 110 may be obtained.

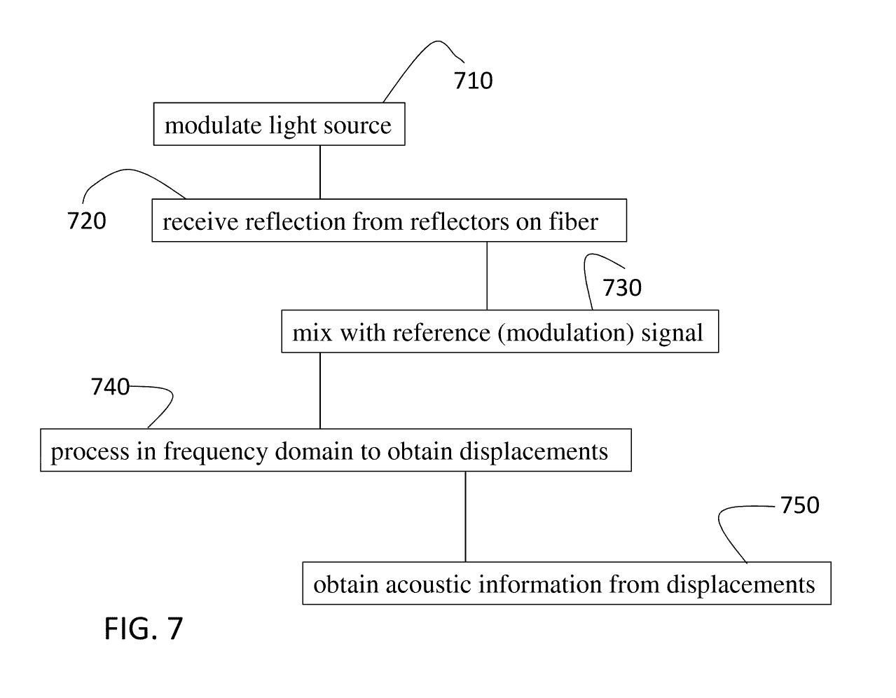

FIG. 7 is a process flow of a method of obtaining acoustic measurements along a fiber 110 according to an embodiment of the invention. At block 710, modulating the light source includes modulating the laser source 210 output beam 212 with the modulation signal 214 before sending the resultant modulated signal 216 on the fiber 110. Receiving the reflection from reflectors 115 on the fiber 110 at block 720 includes converting the received reflected light 217 to an electronic signal 218. At block 730, mixing with the reference signal (modulation signal 214) includes mixing the electronic signal 218 to generate the output signal 230. As noted above, the output signal 230 is further processed by a processor 240 (e.g., the surface processing system 130). At block 740, processing in the frequency domain to obtain displacements includes obtaining a Fourier transform of the output signal 230 to obtain the detected signal 242 and using demodulation techniques to find the displacements associated with the respective reflectors 115. Obtaining acoustic information from the displacements at block 750 includes computing the difference between the obtained displacements to isolate the acoustic contribution to the resulting signal.

While one or more embodiments have been shown and described, modifications and substitutions may be made thereto without departing from the spirit and scope of the invention. Accordingly, it is to be understood that the present invention has been described by way of illustrations and not limitation.

1. A system to obtain acoustic information from a borehole penetrating the earth, the system comprising:
a light source configured to provide a continuous output beam over a selected period of time;
a modulator configured to modulate the continuous output beam with a modulation signal to provide a frequency modulated continuous wave (FMCW) to be sent out on an optical fiber disposed along the borehole, the optical fiber including a plurality of reflectors at known locations along the optical fiber; and
a processor configured to process a light reflection signal from the optical fiber to determine the acoustic information.

2. The system according to claim 1, wherein the light source is a laser.

3. The system according to claim 1, wherein the modulator is configured to modulate the continuous output beam with a modulation signal having a sinusoidal envelope whose frequency is swept linearly over time over a given range.

4. The system according to claim 1, wherein the processor is further configured to convert the light reflection signal reflected by the fiber to an electronic signal.

5. The system according to claim 4, wherein the processor is further configured to mix the electronic signal with the modulation signal and perform a Fourier transform on a resulting signal to output a detected signal in a frequency domain.

6. The system according to claim 5, wherein the processor is further configured to demodulate the detected signal to determine a displacement of each of the plurality of reflectors.

7. The system according to claim 6, wherein the processor is further configured to obtain the acoustic information based on a difference between the displacements.

8. The system according to claim 4, wherein the processor is further configured to mix the electronic signal with a time delayed version of the modulation signal and perform a Fourier transform on a resulting signal to output a detected signal in a frequency domain.

9. The system according to claim 8, wherein the processor is further configured to demodulate the detected signal to determine a displacement of each of the plurality of reflectors and to obtain the acoustic information based on a difference between the displacements.

10. A method of obtaining acoustic information from a borehole penetrating the earth, the method comprising:
disposing an optical fiber along the borehole, the optical fiber including a plurality of reflectors at known locations along the optical fiber;
modulating a continuous output beam with a modulation signal to provide a frequency modulated continuous wave (FMCW) to be sent out on the optical fiber; and
processing a light reflection signal from the optical fiber to determine the acoustic information.

11. The method according to claim 10, wherein the modulating is with a modulation signal that has a sinusoidal envelope whose frequency is swept linearly over time over a given range.

12. The method according to claim 10, wherein the processing includes converting the light reflection signal to an electronic signal.

13. The method according to claim 12, wherein the processing includes mixing the electronic signal with the modulation signal and performing a Fourier transform to output a detected signal in a frequency domain.

14. The method according to claim 13, wherein the processing includes demodulating the detected signal to determine a displacement of each of the plurality of reflectors.

15. The method according to claim 14, wherein the processing includes obtaining the acoustic information based on a difference between the displacements.

16. The method according to claim 12, wherein the processing includes mixing the electronic signal with a time delayed version of the modulation signal and performing a Fourier transform to output a detected signal in a frequency domain.

17. The method according to claim 16, wherein the processing includes demodulating the detected signal to determine a displacement of each of the plurality of reflectors and obtaining the acoustic information based on a difference between the displacements.
